(19) United States
(12) Patent Application Publication
(10) Pub. No.: US 2014/0342177 A1
(43) Pub. Date: Nov. 20, 2014

(54) SYNTHESIS OF CUPRONICKEL NANOWIRES AND THEIR APPLICATION IN TRANSPARENT CONDUCTING FILMS

(71) Applicant: DUKE UNIVERSITY, Durham, NC (US)

(72) Inventor: Benjamin Wiley, Durham, NC (US)

(73) Assignee: DUKE UNIVERSITY, Durham, NC (US)

(21) Appl. No.: 14/363,226

(22) PCT Filed: Dec. 6, 2012
(86) PCT No.: PCT/US2012/068176

§ 371 Date: Jun. 5, 2014

Related U.S. Application Data
(60) Provisional application No. 61/567,740, filed on Dec. 7, 2011.

(51) Int. Cl. H01B 1/02; B22F 9/16; H01B 1/22; B22F 1/02

(52) U.S. Cl. CPC H01B 1/026; B22F 1/025; B22F 9/16; H01B 1/22
USPC 428/605; 75/351; 428/607

(57) ABSTRACT

A method of synthesis to produce a conductive film including cupronickel nanowires. Cupronickel nanowires can be synthesized from solution, homogeneously dispersed and printed to make conductive films (preferably <1,000 Ω/sq) that preferably transmit greater than 60% of visible light.

### FIELD

The present disclosure relates generally to the field of copper nanowires. Specifically, the present disclosure relates to copper nanowires that have been coated and alloyed with nickel to form cupronickel nanowires, cupronickel nanowire structures, cupronickel nanowire dispersion compositions, cupronickel nanowire-containing films, and methods of making said cupronickel nanowires.

### BACKGROUND

Transparent conductors are used in a wide variety of applications, including low-emissivity windows, flat-panel displays, touch-sensitive control panels, solar cells and for electromagnetic shielding (Gordon 2000). The market for flat-panel displays alone is worth approximately $90 billion per year. Display makers tend to use Indium Tin Oxide (ITO) as the transparent conductor because it can be applied at relatively low temperatures, and is easier to etch than materials with comparable conductivities and transmissivities (Gordon 2000). ITO films can be made with a sheet resistance of 10 Ω/sq and can transmit about 90% of visible light (Chopra 1983). Limitations of ITO include the fact that a) it is brittle, and thus can not be used in flexible displays, b) the sputtering process used to make ITO films is highly inefficient, depositing only 30% of an ITO target onto a substrate (U.S. Geological Survey, Indium), c) Indium is a scarce element, present in the earth's crust at concentrations of only 0.05 parts per million (Taylor 1995). The limited supply and increasing demand of indium for use in flat panel displays, which represent 80% of indium consumption, has led to a recent price increase of 745%, from $94/kg in 2002, to about $800/kg in 2011 (U.S. Geological Survey, Indium).

The lack of flexibility, inefficient processing, and high cost of ITO films has motivated a search for alternatives Films of carbon nanotubes have been extensively explored as one possible alternative, but carbon nanotube films have yet to match the properties of ITO (Kaempgen 2005, Lagemaat 2006). More recently, researchers have shown flexible films of silver nanowires have conductivities and transmittances comparable to ITO (De, ACSNano, 2009), but silver is also similar to ITO in price ($1400/kg) and scarcity (0.05 ppm) (U.S. Geological Survey, Silver).

Copper is 1000 times more abundant that indium or silver, and is 150 times less expensive ($9/kg). Films of copper nanowires (CuNWs) could thus represent a low-cost alternative to silver nanowires or ITO for use as a transparent electrode. Disadvantageously, films of copper nanowires appear slightly pink in color, which is an undesirable feature for displays in consumer electronics. Moreover, films of copper nanowires are prone to oxidation, especially at higher temperatures, which renders them non-conductive.

A one pot approach was previously described by Zhang S. et al., (Chem. Mater., 22, 1282-1284 (2010)), whereby copper salt, nickel salt, reducing agent, and other components such as hydroxides were combined, resulting in the formation of a central copper core and nickel sheath whereby both the copper cores and the deposited nickel were essentially single-crystalline. Moreover, they are relatively thick, having a constant diameter of about 200-300 nm, which precludes making a transparent conductive film using these nanowires.

It is therefore an object of the present invention to provide improved copper nanowires, in particular nanowires comprising copper alloyed with nickel, and methods of making said cupronickel nanowires (NiCuNWs). The methods described herein provide for the large-scale synthesis of NiCuNWs and their transfer to a substrate to make transparent, conductive electrodes with properties comparable to ITO.

### SUMMARY

The present disclosure relates to novel cupronickel nanowire (NiCuNW) structures, which comprise a substantially copper core surrounded by a shell comprising a cupronickel alloy, a novel dispersion of NiCuNWs in which they are free from aggregation, methods of synthesizing nanowires to produce said dispersion at a large scale, and cupronickel nanowire containing films

In one aspect, a cupronickel nanowire is described, wherein said nanowire comprises comprise a substantially copper core with a cupronickel alloy shell and has a length of about 1 to 500 microns, preferably about 10 to about 50 microns, and a diameter of about 10 nm to 1 micron, preferably about 70 to about 120 nm. The cupronickel shell has a polycrystalline arrangement.

In another aspect, a conductive film comprising a network of cupronickel nanowires (NiCuNWs) is described, said conductive film having a sheet resistance of less than about 1,000 Ω/sq. In one embodiment, the conductive film has a transparency greater than about 60%.

In still another aspect, a method of producing cupronickel nanowires (NiCuNWs) is described, said method comprising:
combining copper nanowires (CuNWs), at least one nickel salt, at least one reducing agent, at least one surfactant, and at least one solvent to form a mixture;
reacting the mixture for time necessary to reduce the nickel ions to form NiCuNWs.
   Preferably, the reacting comprises heating.

In still another aspect, a method of producing cupronickel nanowires (NiCuNWs) is described, said method comprising:
combining copper nanowires (CuNWs), at least one nickel salt, at least one reducing agent, at least one surfactant, and at least one solvent to form a mixture, wherein the mixture does not include a hydroxide salt such as NaOH; and
reacting the mixture for time necessary to reduce the nickel ions to form NiCuNWs.
   Preferably, the reacting comprises heating.

In yet another aspect, a method of making a conductive film comprising a network of cupronickel nanowires (NiCuNWs) is described, said conductive film having a sheet resistance of less than about 1,000 Ω/sq, said method comprising printing a dispersion comprising NiCuNWs.

These and other novel features and advantages of the disclosure will be fully understood from the following detailed description and the accompanying drawings.

### BRIEF DESCRIPTION OF THE DRAWINGS

FIGS. 1A-1C: Energy dispersive x-ray spectroscopy of copper nanowire coated with 54 mol % nickel.

FIG. 1D is a TEM image of a copper nanowire before coating with nickel.

FIG. 1E is a TEM image of a copper nanowire after coating with nickel.

FIGS. 1F-1G are TEM images of the cupronickel nanowires showing the polycrystalline coating having a grain size on the order of 10 nm

FIG. 2A illustrates the transmittance versus the sheet resistance for copper nanowires and cupronickel nanowires comprising 10 mol % Ni, 21 mol % Ni, 34 mol % Ni and 54 mol % Ni.

FIG. 2B illustrates the transmittance versus the sheet resistance for cupronickel nanowires comprising 54 mol % Ni following an anneal in hydrogen, nitrogen, air, and forming gas.

FIG. 2C illustrates the sheet resistance versus time for cupronickel nanowires comprising 0 mol % Ni, 10 mol % Ni, 21 mol % Ni, 34 mol % Ni and 54 mol % Ni and having 85-87% T heated to 85° C.

FIG. 2D illustrates the sheet resistance versus time for cupronickel nanowires comprising 0 mol % Ni, 10 mol % Ni, 21 mol % Ni, 34 mol % Ni and 54 mol % Ni and having 85-87% T heated to 175° C.

FIG. 3 illustrates the absorbance, reflectance, diffuse transmittance and specular transmittance of cupronickel nanowires comprising 0 mol %, 10 mol % Ni, 21 mol % Ni, 34 mol % Ni and 54 mol % Ni.

FIG. 4 is the dark-field microscopy images of cupronickel nanowire films of increasing density.

### DETAILED DESCRIPTION OF THE EMBODIMENTS

Unless otherwise defined, all technical terms used herein have the same meaning as commonly understood by one of ordinary skill in the art to which this disclosure belongs.

The articles “a” and “an” are used herein to refer to one or to more than one (i.e. at least one) of the grammatical object of the article. By way of example, “an element” means at least one element and can include more than one element.

As defined herein, “coating” the copper nanowires with nickel describes a process whereby nickel is reduced on the copper nanowire and forms an alloy with the copper to form a cupronickel alloy shell.

As defined herein, a “shell” corresponds to a layer that comprises both nickel and copper wherein the amount of nickel is greater than the amount of copper and wherein the nickel and copper are alloyed.

The present disclosure relates to novel cupronickel nanowire (NiCuNW) structures, which comprise a substantially copper core surrounded by a shell comprising a cupronickel alloy, a novel dispersion of NiCuNWs in which they are free from aggregation, methods of synthesizing nanowires to produce said dispersion at a large scale, and cupronickel nanowire containing films Transparent electrodes made from these new, well-dispersed cupronickel nanowires perform at the same level as silver nanowires, producing electrodes with sheet resistances under about 1000 Ω/sq, more preferably less than 100 Ω/sq, and most preferably less than 30 Ω/sq, and transparencies greater than 60%, preferably greater than 70% and most preferably transparencies greater than 85%.

The present authors previously disclosed novel copper nanowire (CuNWs) structures, copper nanowire dispersion compositions, copper nanowire-containing films, and methods of making said copper nanowires in International Patent Application No. PCT/US2010/059236 filed on Dec. 7, 2010 entitled “Compositions and Methods for Growing Copper Nanowires,” and U.S. Provisional Patent Application No. 61/481,523 filed on May 2, 2011 entitled “Compositions and Methods for Growing Copper Nanowires,” both of which are hereby incorporated by reference herein in their entirety. In general, PCT/US2010/059236 relates to methods of producing CuNWs comprising, consisting of, or consisting essentially of mixing a copper (II) ion source, at least one reducing agent, at least one copper capping agent, and at least one pH adjusting species to form a first solution; maintaining the first solution for time and temperature necessary to reduce the copper (II) ions; adding a second solution comprising water and at least one surfactant to create a mixture; and maintaining the mixture at time and temperature necessary to form CuNWs. In general, 61/481,523 relates to methods of producing CuNWs comprising, consisting of, or consisting essentially of mixing a copper (II) ion source, at least one reducing agent, at least one copper capping agent, and at least one pH adjusting species to form a solution; stirring and heating the solution for time necessary to reduce the copper (II) ions; collecting formed CuNWs; and washing formed CuNWs with a wash solution. The copper nanowires described in these incorporated applications were long (>20 μm), thin (<60 nm in diameter), and well dispersed. When coated onto plastic substrates using a Mayer rod, transparent conducting films having a sheet resistance of 30 Ωsq⁻¹ at a transmittance of 85% was obtained. The copper nanowires could carry high currents (>500 mA cm⁻²), were stable in air for over a month, and could be bent 1000 times without any degradation in their properties. Disadvantageously, films of copper nanowires appear slightly pink in color, which is an undesirable feature for displays in consumer electronics. Moreover, films of copper nanowires are prone to oxidation, especially at higher temperatures, which renders them non-conductive.

Surprisingly, the present inventors discovered that copper nanowires that are coated and alloyed with nickel results in the formation of cupronickel nanowires that are neutral in color, are stabilized against oxidation at above ambient temperatures and/or humid conditions, can be aligned in magnetic fields, and can be made into a transparent conducting film with a high transmittance and a low sheet resistance. Moreover, the cupronickel nanowires are dispersible and the nickel is homogeneously distributed on the copper nanowires.

In one aspect, a method of making cupronickel nanowires (NiCuNWs) is described, said method comprising, consisting of, or consisting essentially of: combining copper nanowires (CuNWs), at least one nickel salt, at least one reducing agent, at least one surfactant, and at least one solvent to form a mixture; reacting the mixture for time necessary to reduce the nickel ions to form NiCuNWs; collecting the formed NiCuNWs; and optionally washing the formed NiCuNWs. In one embodiment, the method of making cupronickel nanowires (NiCuNWs) comprises, consists of, or consists essentially of: combining copper nanowires (CuNWs), at least one nickel salt, at least one reducing agent, at least one surfactant, and at least one solvent to form a mixture; heating the mixture for time necessary to reduce the nickel ions to form NiCuNWs; collecting the formed NiCuNWs; and optionally washing the formed NiCuNWs. The NiCuNWs collected comprise a substantially copper core with a cupronickel alloy shell and have a length of about 1 to 500 microns, preferably about 10 to about 50 microns, and a diameter of about 10 nm to 1 micron, preferably about 70 to about 120 nm. The cupronickel shell has a polycrystalline arrangement. The NiCuNWs collected can be used to form transparent electrodes having a high transmittance and a low sheet resistance.

Based on the present inventors own research, nanowires comprising nickel and copper made in a milieu comprising hydroxide salts such as NaOH are (a) not dispersible and hence it is not possible to form transparent conducting films, and (b) the nickel is not homogeneously distributed on the copper nanowires, and as a result is not effective at protecting them from oxidation. Accordingly, in a preferred embodiment, the method of making cupronickel nanowires (NiCuNWs) comprises, consists of, or consists essentially of: combining copper nanowires (CuNWs), at least one nickel salt, at least one reducing agent, at least one surfactant, and at least one solvent to form a mixture wherein the mixture has less than 30% of hydroxide salts, more preferably has less than 1% of hydroxide salts, even more preferably has less than 100 ppm hydroxide salts, and most preferably has no hydroxide salts such as NaOH; heating the mixture for time necessary to reduce the nickel ions to form NiCuNWs; collecting the formed NiCuNWs; and optionally washing the formed NiCuNWs. The NiCuNWs collected comprise a substantially copper core with a cupronickel alloy shell and have a length of about 1 to 500 microns, preferably about 10 to about 50 microns, and a diameter of about 10 nm to 1 micron, preferably about 70 to about 120 nm. The cupronickel shell has a polycrystalline arrangement. The NiCuNWs collected can be used to form transparent electrodes having a high transmittance and a low sheet resistance.

In certain embodiments, the mixture is agitated or mixed after the addition of each component thereto. The mixture is preferably heated to temperature in a range from about 50° C. to about 150° C., preferably about 100° C. to about 130° C., preferably without any stirring. Collecting the NiCuNWs is easily effectuated by removing the NiCuNWs from the mixture, whereby said removal is done by draining, withdrawing, decanting, or any other means known in the art of solid/liquid separation. The washing and collecting comprise, consist of, or consist essentially of dispersing the formed NiCuNWs in a wash solution, optionally vortexing, and centrifuging the wash solution, e.g., at 2000 rpm, for at least 5 minutes. The NiCuNWs can then be separated from the wash solution and the washing process repeated as necessary.

Copper nanowire sources include, but are not limited to, the copper nanowires produced based on the disclosures of International Patent Application No. PCT/US2010/059236, U.S. Provisional Patent Application No. 61/481,523, both of which are incorporated by reference herein, or any other means whereby a copper nanowire is produced. CuNWs can be purchased from NanoForge, Inc., Durham, N.C., USA. The CuNWs may be a dry solid or alternatively in a CuNW dispersion comprising at least one surfactant and at least one solvent. For example, the CuNWs can be in an aqueous dispersion comprising 1 wt % PVP and 1 wt % diethylhydroxylamine.

Reducing agents contemplated include, but are not limited to, hydrazine, ascorbic acid, L(+)-ascorbic acid, isoascorbic acid, ascorbic acid derivatives, oxalic acid, formic acid, phosphites, phosphorous acid, sulfites, sodium borohydride, and combinations thereof Preferably, the reducing agent comprises hydrazine

Surfactants contemplated herein include, but are not limited to, water soluble polymers such as polyethylene glycol (PEG), polyethylene oxide (PEO), polypropylene glycol, polyvinyl pyrrolidone (PVP), cationic polymers, nonionic polymers, anionic polymers, hydroxyethylcellulose (HEC), acrylamide polymers, poly(acrylic acid), carboxymethylcellulose (CMC), sodium carboxymethylcellulose (Na CMC), hydroxypropylmethylcellulose, polyvinylpyrrolidone (PVP), BIOCARE™ polymers, DOW™ latex powders (DLP), ETHOCEL™ ethylcellulose polymers, KYTAMER™ PC polymers, METHOCEL™ cellulose ethers, POLYOX™ water soluble resins, SoftCAT™ polymers, UCARE™ polymers, gum arabic, sorbitan esters (e.g., sorbitan monolaurate, sorbitan monopalmitate, sorbitan monostearate, sorbitan tristearate, sorbitan monooleate, sorbitan trioleate), polysorbate surfactants (e.g., polyoxyethylene (20) sorbitan monolaurate, polyoxyethylene (20) sorbitan monopalmitate, polyoxyethylene (20) sorbitan monostearate, polyoxyethylene (20) sorbitan monooleate, polyoxyethylene sorbitan trioleate, polyoxyethylene sorbitan tristearate), and combinations thereof. Other surfactants contemplated include: cationic surfactants such as cetyltrimethylammonium bromide (CTAB), hexadecyltrimethylammonium bromide (HTAB), cetyltrimethylammonium hydrogen sulfate; anionic surfactants such as sodium alkyl sulfates, e.g., sodium dodecyl sulfate, ammonium alkyl sulfates, alkyl (C₁₀-C₁₈) carboxylic acid ammonium salts, sodium sulfosuccinates and esters thereof, e.g., dioctyl sodium sulfosuccinate, alkyl (C₁₀-C₁₈) sulfonic acid sodium salts, and the di-anionic sulfonate surfactants DowFax (The Dow Chemical Company, Midland, Mich., USA); and nonionic surfactants such as t-octylphenoxypolyethoxyethanol (Triton X100) and other octoxynols. Most preferably, the surfactant comprises PVP.

Nickel salts contemplated include, but are not limited to, nickel (II) salts such as nickel (II) acetate, nickel (II) acetate tetrahydrate, nickel (II) bromide, nickel (II) carbonate, nickel (II) chlorate, nickel (II) chloride, nickel (II) cyanide, nickel (II) fluoride, nickel (II) hydroxide, nickel (II) bromate, nickel (II) iodate, nickel (II) iodate tetrahydrate, nickel (II) iodide, nickel (II) nitrate hexahydrate, nickel (II) oxalate, nickel (II) orthophosphate, nickel (II) pyrophosphate, nickel (II) sulfate, nickel (II) sulfate heptahydrate, and nickel (II) sulfate hexahydrate. Preferably, the nickel salt comprises nickel (II) nitrate.

Solvents contemplated herein include water, water miscible solvents, or a combination of water and water-miscible solvents, wherein the water miscible solvents include alcohols, glycols, and glycol ethers selected from the group consisting of methanol, ethanol, isopropanol, butanol, ethylene glycol, propylene glycol, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof Preferably, the solvent comprises, consists of, or consists essentially of a water-miscible solvent such as ethylene glycol or propylene glycol.

The wash solution is preferably aqueous in nature and can comprise, consist of, or consist essentially of water, hydrazine, a surfactant, or any combination thereof

In one embodiment of the first aspect, a method of making cupronickel nanowires (NiCuNWs) is described, said method comprising, consisting of, or consisting essentially of: combining copper nanowires (CuNWs), at least one nickel salt, at least one reducing agent, PVP, and at least one solvent to form a mixture, wherein the mixture has less than 30% of hydroxide salts, more preferably has less than 1% of hydroxide salts, even more preferably has less than 100 ppm hydroxide salts, and most preferably has no hydroxide salts such as NaOH; heating the mixture for time necessary to reduce the nickel ions to form NiCuNWs; collecting the formed NiCuNWs; and optionally washing the formed NiCuNWs. In another embodiment, a method of making cupronickel nanowires (NiCuNWs) is described, said method comprising, consisting of, or consisting essentially of: combining copper nanowires (CuNWs), hydrazine, PVP, at least one nickel salt, and at least one solvent to form a mixture, wherein the mixture has less than 30% of hydroxide salts, more preferably has less than 1% of hydroxide salts, even more preferably has less than 100 ppm hydroxide salts, and most preferably has no hydroxide salts such as NaOH; heating the mixture for time necessary to reduce the nickel ions to form NiCuNWs; collecting the formed NiCuNWs; and optionally washing the formed NiCuNWs. In still another embodiment of the first aspect, a method of making cupronickel nanowires (NiCuNWs) is described, said method comprising, consisting of, or consisting essentially of combining copper nanowires (CuNWs), hydrazine, PVP, ethylene glycol, and at least one nickel salt to form a mixture wherein the mixture has less than 30% of hydroxide salts, more preferably has less than 1% of hydroxide salts, even more preferably has less than 100 ppm hydroxide salts, and most preferably has no hydroxide salts such as NaOH; heating the mixture for time necessary to reduce the nickel ions to form NiCuNWs; collecting the formed NiCuNWs; and optionally washing the formed NiCuNWs.

Following the appropriate wash and collection, the NiCuNWs may be stored in the solution is aqueous and comprises water, hydrazine, a surfactant, an alcohol, or combinations thereof Alcohols contemplated herein include straight chained or branched C₁-C₆ alcohols such as methanol, ethanol, propanol, butanol, pentanol, and hexanol. Preferably, the storage solution comprises, consists of, or consists essentially of dispersed NiCuNWs, water, and hydrazine; dispersed NiCuNWs, water, hydrazine and PVP; or dispersed NiCuNWs, water, and ethanol. For example, the NiCuNW dispersion can comprise, consist of or consist essentially of NiCuNWs and a storage solution, wherein the NiCuNWs are substantially free of aggregation, and wherein the storage solution comprises a species selected from the group consisting of hydrazine, at least one surfactant, at least one alcohol, water, and a combination thereof. As defined herein, “substantially free” corresponds to less than about 5 wt % of the total weighed amount of NiCuNWs are aggregated, preferably less than about 2 wt %, and most preferably less than 1 wt % of the total weighed amount of NiCuNWs are aggregated. In this context, “aggregated” refers to the formation of clumps of nanowires due to their mutual van der Waals attraction. Such clumps may consist of as few as two nanowires, and as many as 10¹² nanowires or more. Formation of clumps is generally not reversible in this context, and thus is preferably prevented in order to ensure the film consists of a network of individual wires, rather than clumps. Clumps reduce the transmittance of films, and do not improve the conductivity. Such clumps can easily be identified in a film with a dark field optical microscope, or a scanning electron microscope. It is preferred that the nanowire film contain a minimal amount of clumps in order to reach properties comparable with ITO (<30 Ω/sq, >85% transmittance).

In another aspect, novel cupronickel nanowire structures are described, wherein the cupronickel nanowire structures comprise a substantially copper core with a cupronickel alloy shell and have a length of about 1 to 500 microns, preferably about 10 to about 50 microns, and a diameter of about 10 nm to 1 micron, preferably about 70 to about 120 nm. The cupronickel shell has a polycrystalline arrangement.

The nanowire structure, dispersion and production methods described herein have many practical applications including, but not limited to, (1) the ability to coat the nanowires directly from a solution onto both rigid and flexible substrates to produce transparent conductive films that can subsequently be patterned; (2) the ability to use printing processes with conductive inks incorporating copper nanowires to make conductive metal lines, shapes, characters, patterns, etc.; and (3) the ability to use the copper nanowires as an additive to pastes, glues, paints, plastics, and composites to create electrically conductive materials.

Accordingly, another aspect relates to a method further of printing the formed NiCuNWs onto substrates for use as conductive films For example, the formed NiCuNWs may be coated directly from a solution onto rigid substrates, flexible substrates, or combinations thereof, to produce conductive films that can be subsequently patterned. Preferably, the conductive films are transparent and made from the NiCuNWs prepared using the processes described herein, wherein said transparent conductive films perform similarly to silver nanowires by having sheet resistances less than about 1000 Ω/sq, more preferably less than 100 Ω/sq, and most preferably less than 30 Ω/sq, and transparencies greater than about 60%, preferably greater than about 70%, and most preferably greater than about 85%. In general, any deposition method, including those that are used in web coating or roll-to-roll processes, that involves deposition of material from a liquid phase onto a substrate can be applied to making films of nanowires. Examples of such deposition processes include the Mayer rod process, air-brushing, gravure, reverse roll, knife over roll, metering rod, slot die, immersion, curtain, and air knife coating. In one embodiment, a method of producing a conductive cupronickel-containing film, e.g., an electrode, is described, said method comprising depositing a layer of NiCuNWs from a NiCuNW dispersion onto a substrate using a deposition process. The film can comprise, consist of or consist essentially of a network of NiCuNWs or a network of NiCuNWs and at least one supportive material, wherein the supportive material includes, but is not limited to, cellulose materials, glues, polymeric materials (e.g., polyethylene terephthalate, polyethylene naphthalate and poly(4,4′-oxydiphenylene-pyromellitimide), general overcoat materials, e.g., oxygen and moisture impervious bathers, or any combination thereof, as readily known by one skilled in the art. Preferably the sheet resistance of the cupronickel-containing film is less than about 1000 Ω/sq, even more preferably less than 100 Ω/sq, and most preferably less than 30 Ω/sq. As defined herein, a “network” corresponds to an arrangement of wires such that the wires are interconnected. For a cupronickel nanowire film to be conductive, at least one path of interconnected wires must traverse between the electrodes where electrical contact is made. In another embodiment, a method of producing a conductive, transparent cupronickel-containing film is described, said method comprising depositing a layer of NiCuNWs from a NiCuNW dispersion onto a substrate using a deposition process. The film can comprise, consist of or consist essentially of a network of NiCuNWs or a network of NiCuNWs and at least one supportive material, wherein the supportive material includes, but is not limited to, cellulose materials, glues, polymeric materials (e.g., polyethylene terephthalate), general overcoat materials, or any combination thereof, as readily known by one skilled in the art. Preferably, the sheet resistance of the cupronickel-containing film is less than about 1000 Ω/sq, even more preferably less than 100 Ω/sq, and most preferably less than 30 Ω/sq, and the transparency greater than about 60%, preferably greater than about 70%, and most preferably greater than about 85%. The cupronickel-containing films preferably are used as transparent electrodes. As defined herein, a “film” of nanowires corresponds to a thin covering of nanowires on a surface. The film may consist solely of nanowires, or of nanowires with supportive materials. For example, the NiCuNWs in a material (i.e., an ink) may be coated onto a polymeric material to form a conductive film. For the film to be conducting, the nanowires preferably form an interconnecting network within the film.

Further, any method that can be used to pattern materials can be used to pattern films of nanowires including, but not limited to, Ink Jet, Gravure, Screen, and other printing processes. For this application, nanowires can be suspended in an organic or aqueous solution at an appropriate concentration to make a conducting film. Nanowires can also be suspended in photocurable monomer mixtures and selectively cured with UV light to create a pattern of conductive material. Nanowires can also be patterned with subtractive processes. For example, after casting a film of nanowires onto a surface, specific areas can be chemically etched away or a sticky rubber stamp can be applied to remove the nanowires.

In another aspect, subsequent to the extraction of the synthesized nanowires from the reaction vessel, the unused reaction ingredients are utilized in further synthesis cycles, which advantageously reduces the cost of nanowire production, as well as waste. In a preferred embodiment, the method for recycling ingredients from a prior production of NiCuNWs to produce NiCuNWs comprises, consists of, or consists essentially of collecting the NiCuNWs from the mixture; and reusing the solution comprising the aforementioned components, wherein the nickel salt and optionally additional species are replenished to produce new solution.

Surprisingly, the addition of nickel to the copper nanowires greatly improves their resistance to oxidation under a variety of conditions. For example, copper nanowires must be annealed under a pure hydrogen atmosphere to be made into conductive films; if inert atmospheres are used, the films do not become conductive. In contrast, cupronickel nanowires can be annealed under either hydrogen or forming gas (e.g., about 5% hydrogen and about 95% nitrogen) with the same effect. This is significant because forming gas is not as explosive as pure hydrogen, and is less expensive. Furthermore, it has been found that the cupronickel nanowires can be annealed under nitrogen and air to make highly conductive films, with no significant difference between the two atmospheres.

In another aspect, a cupronickel-containing film comprising, consisting of, or consisting essentially of a network of NiCuNWs and at least one supportive material is processed to remove the supportive material to yield a network of NiCuNWs. Accordingly, a method of annealing a cupronickel-containing film comprising a network of NiCuNWs and at least one supportive material is described, said method comprising heating the cupronickel-containing film in a reducing atmosphere at a temperature that removes the supportive material from the cupronickel-containing film to yield a network of NiCuNWs. Preferably, the reducing atmosphere comprises hydrogen gas and the anneal is carried out at temperature in a range from about 100° C. to about 500° C., preferably about 350° C., for time in a range from about 0.1 min to about 180 min, preferably about 20 min to about 40 min, and most preferably about 30 min. In one embodiment, the reducing atmosphere is hydrogen gas. In another embodiment, the reducing atmosphere is forming gas and comprises hydrogen and nitrogen.

In still another aspect, the cupronickel-containing film comprising, consisting of, or consisting essentially of a network of NiCuNWs and at least one supportive material is processed in a plasma to remove components of the supportive material. Subsequent to the plasma clean, the network of NiCuNWs can be annealed as described herein.

In another aspect, a method of protecting copper nanowires from high temperatures and/or humid conditions is described, said method comprising depositing a cupronickel alloy on the copper nanowires, wherein the cupronickel alloy is deposited on the copper nanowires by: combining copper nanowires (CuNWs), at least one nickel salt, at least one reducing agent, at least one surfactant, and at least one solvent to form a mixture; reacting the mixture for time necessary to reduce the nickel ions to form NiCuNWs; collecting the formed NiCuNWs; and optionally washing the formed NiCuNWs. Preferably, the reacting comprises heating. In addition, preferably, the mixture has less than 30% of hydroxide salts, more preferably has less than 1% of hydroxide salts, even more preferably has less than 100 ppm hydroxide salts, and most preferably has no hydroxide salts such as NaOH. The NiCuNWs collected comprise a substantially copper core with a cupronickel alloy shell and have a length of about 1 to 500 microns, preferably about 10 to about 50 microns, and a diameter of about 10 nm to 1 micron, preferably about 70 to about 120 nm. The cupronickel shell has a polycrystalline arrangement.

The high transmittance and high conductivity of the NiCuNW films described herein, combined with their extremely low cost, make them a promising transparent conductor for use in low cost flexible displays, low-emissivity windows, and thin film solar cells.

### EXAMPLE 1

Nickel coated copper nanowires (NiCuNWs) were synthesized by combining 1 mg CuNWs (dispersed in an aqueous solution of polyvinylpyrrolidone (1 wt %) and diethylhydroxylamine (1 wt %), NanoForge, Inc., Durham, N.C., USA), 15.7, 39.3, 78.7. or 157.4 μL of a 0.1 M Ni(NO₃)₂.6H₂O stock solution, and hydrazine (132 μL 35 wt %) to a 20 mL scintillation vial containing a solution of 2 wt % polyvinylpyrrolidone (PVP) dissolved in ethylene glycol (1.316 mL) to form a mixture. The mixture was vortexed for 15 seconds and heated at 120° C. for 10 minutes without any stirring. During the heating step. the dispersed CuNWs became aggregated, floated to the top of the solution, and changed from a copper color to a dark copper or black color (depending on Ni concentration) due to Ni reducing onto the surface of the CuNWs. After heating for 10 minutes the liquid under the floating nanowires was decanted with a pipette and the cupronickel nanowires (NiCuNWs) were dispersed in an aqueous wash solution of PVP (1 wt %) and hydrazine (3 wt %). This wash solution was then centrifuged at 2000 rpm for 5 minutes, and the supernate was decanted from the nanowires. The wires were then dispersed in a fresh aqueous wash solution (containing 3 wt % hydrazine and 1 wt % PVP) by vortexing for 30 seconds, and then centrifuged and decanted one more time. This cycle was repeated two additional times using an aqueous wash solution containing only hydrazine (3 wt %). A dispersion of NiCuNWs resulted.

Transparent electrodes were made by washing the NiCuNWs at least three times using an aqueous solution of hydrazine (3 wt %) containing no PVP to ensure any residual PVP was removed. After the PVP was removed, the NiCuNWs were washed with ethanol to remove the majority of the water. An ink formulation was made separately by dissolving nitrocellulose (0.06 g) in acetone (2.94 g) and then adding ethanol (3 g), ethyl acetate (0.5 g), pentyl acetate (1 g), isopropanol (1 g), and toluene (1.7 g). The NiCuNWs were washed with the ink formulation, and then 0.3 mL of the ink formulation was added to the NiCuNWs, and this suspension vortexed. If significant amounts of aggregates were present the ink was briefly sonicated (up to 5 seconds) and centrifuged at a low speed (approximately 500 rpm) so that a well dispersed NiCuNW ink could be obtained. To prepare the transparent NiCuNW electrode, glass microscope slides were placed onto a clipboard to hold them down while the NiCuNW ink (25 μL) was pipetted in a line at the top of the slide. A Mayer rod (Gardco #13, 33.3 μm wet film thickness) was then quickly (<1 second) pulled down over the NiCuNW ink by hand, spreading it across the glass into a thin, uniform film. Different densities of nanowires on the surface of the substrate were obtained by varying the concentration of the NiCuNWs in the ink.

To remove the film former and other organic material from the NiCuNW network, the films were cleaned in a plasma cleaner (Harrick Plasma PDC-001) for 15 minutes in an atmosphere of 95% nitrogen and 5% hydrogen at a pressure of 600-700 mTorr. To further clean the NiCuNW electrodes they were heated to 175° C. in a tube furnace for 30 minutes under a constant flow of hydrogen (600 mL min⁻¹) to anneal the wires together and decrease the sheet resistance to below 200 Ωsq⁻¹. The transmittance and sheet resistance of each NiCuNW electrode was measured using a UV/VIS spectrometer (Cary 6000i) and a four-point probe (Signatone SP4-50045TBS).

The nanowires were analyzed using a scanning electron microscope (SEM), FEI XL3O SEM-FEG, a transmission electron microscope (TEM), FEI Tecnai G² Twin, and a scanning transmission electron microscope (STEM), JEOL 2200FS Aberration-Corrected STEM, with an energy dispersive x-ray spectrometer (EDS). The diameters and lengths of the wires were determined by comparing the pixel diameter/length of the wires with the pixel length of the scale bar. To prepare the samples for SEM (FEI XL3O SEM-FEG), a small chip of a silicon (Si) wafer (5 mm×5 mm) was cut for each sample and placed on a piece of double sided tape in a Petri dish. Clean nanowires were dispersed in an aqueous hydrazine (3 wt %) solution with vortexing and sonication before 5 μL of the suspension was placed on a Si chip. The Petri dish was then covered with parafilm and nitrogen gas was gently blown into it to dry the sample, creating a balloon out of the parafilm. After drying overnight, the nanowires were rinsed with a gentle flow of water (approx. 150 mL min⁻¹) for 15-30 seconds and dried again. For TEM, a copper grid was used to hold the nanowires instead of a Si chip. The grid was placed on top of a whatman filter and 3 μL of the well-dispersed nanowire solution was pipetted onto the grid. The solution was absorbed into the filter paper underneath the grid, leaving the majority of the nanowires on the grid. The sample was then allowed to completely dry under a flow of nitrogen gas. The same sample preparation was done for the EDS samples except a nickel grid was used in place of a copper grid.

To measure the concentration of the well-dispersed NiCuNWs, a set volume of the solution was dissolved in concentrated nitric acid (1 mL). The dissolved nickel and copper was then diluted to a set volume. Atomic absorption spectrometry (AAS. Perkin Elmer 3100) was used to measure the concentration of the respective metals.

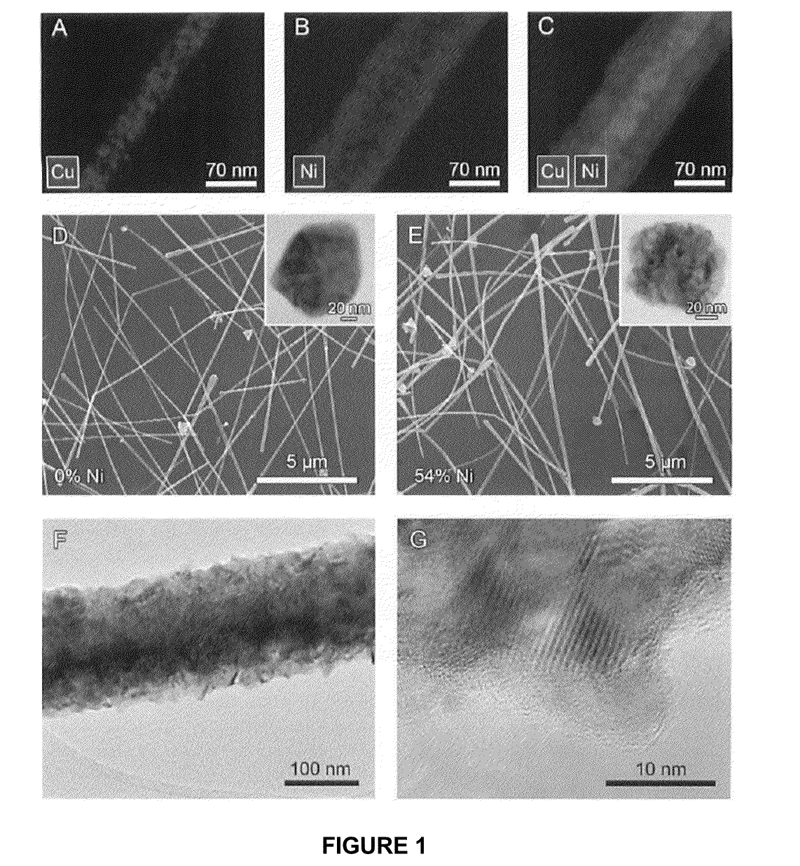

FIGS. 1A-C show energy dispersive x-ray spectroscopic images of a copper nanowire coated with nickel to a content of 54 mol %. As shown in panel A, copper is present not only in the core of the wire, but also diffuses into the nickel shell, creating a shell composed of a cupronickel alloy. Since copper and nickel are completely miscible in all proportions, it is not surprising that the two elements interdiffuse after the nickel coating to form a nanowire consisting of a cupronickel alloy shell. FIG. 1D shows the starting copper nanowires before coating, wherein the CuNWs had an average length of 28.4±7.1 μm and an average diameter of 75±19 nm The inset of FIG. 1D is a TEM image of a microtomed cross-section of a CuNW before nickel coating, showing that it has a 5-fold twinned crystal structure and pentagonal cross-section similar to silver nanowires synthesized in ethylene glycol. After coating to a wire content of 54 mol % Ni, the diameter of the wires increased lo 116±28 nm (FIG. 1E). A TEM cross-section of a microtomed cupronickel nanowire in the inset of FIG. 1E shows the five-fold twin crystal structure becomes distorted and more randomly polycrystalline after alloying. Although not wishing to be bound by theory, this image seems to suggest that the diffusion of nickel into the copper nanowire caused a rearrangement of the copper atoms, and thus the distortion of the original five-fold twin crystal structure. TEM images of a copper nanowire coated with nickel show that the nickel coating is polycrystalline, with a grain size on the order of 10 nm (FIGS. 1F and 1G).

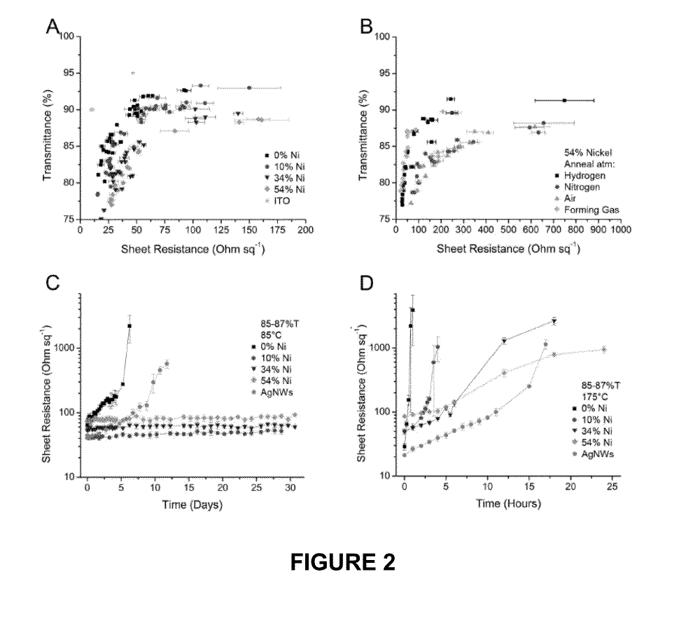

As shown in FIG. 2A, keeping the diameter of the NiCuNW small is critical to obtaining a transparent conducting film with a high transmittance and low sheet resistance. For example, at a sheet resistance of 50 ohm/sq. the transmittance drops from 90.5% to 84% as the nickel coating increases the thickness of the nanowires from 75 nm (0% Ni) to 116 nm (54% Ni).

As previously introduced, unexpectedly, cupronickel nanowires made using the method described herein can be annealed using either hydrogen or forming gas (5% hydrogen, 95% nitrogen) with the same effect (FIG. 2B). This is significant because forming gas is not as explosive as pure hydrogen and is less expensive. Unexpectedly, the cupronickel nanowires can even be annealed under nitrogen and air to make highly conductive films, with no significant difference between the two atmospheres.

To test the resistance of cupronickel nanowires to oxidation, films of comparable transmittance (85-87% T) were put in an oven heated to 85° C. and periodically their sheet resistance was periodically measured over a month. FIG. 2C shows that, without any nickel coating, the sheet resistance of the copper nanowires began to increase after 1 day, and increased by an order of magnitude after 5 days. In comparison, with as little as 10 mol % Ni to Cu, the sheet resistance of the film remained remarkably stable over a period of 28 days, increasing by only 10 ohm/sq. With Ni contents of 34% or greater, the change in the sheet resistance over 30 days is so small as to be within the error of the measurement Thus we can conclude that coating and alloying copper nanowires with nickel gives them excellent protection against oxidation under moderate accelerated testing conditions.

For applications in displays, one target specification is achieving a less than 10% change in sheet resistance after 1 hr at 150° C. To test the stability of the cupronickel nanowires under more extreme conditions, we put the films in a furnace heated to 175° C. In this case, copper nanowires oxidized in less than 15 min. Addition of 10 mol % nickel allowed the sheet resistance of the nanowire film to remain relatively stable over 1 hour. At a nickel content of 54 mol %, the resistivity of the nanowire film increases less that 10 ohm/sq over the course of four hours. This test illustrates that the addition of nickel to the copper nanowires renders them resistant to oxidation even at relatively high temperatures for short periods of time.

In addition to the issue of oxidation, alloying copper with nickel can address the issue of color. The reddish color of copper is an undesirable feature that must he addressed if copper-containing nanowires they are to be used in displays. It was determined that the nanowire films change from a reddish to a grey color around a nickel content of 20-30%.

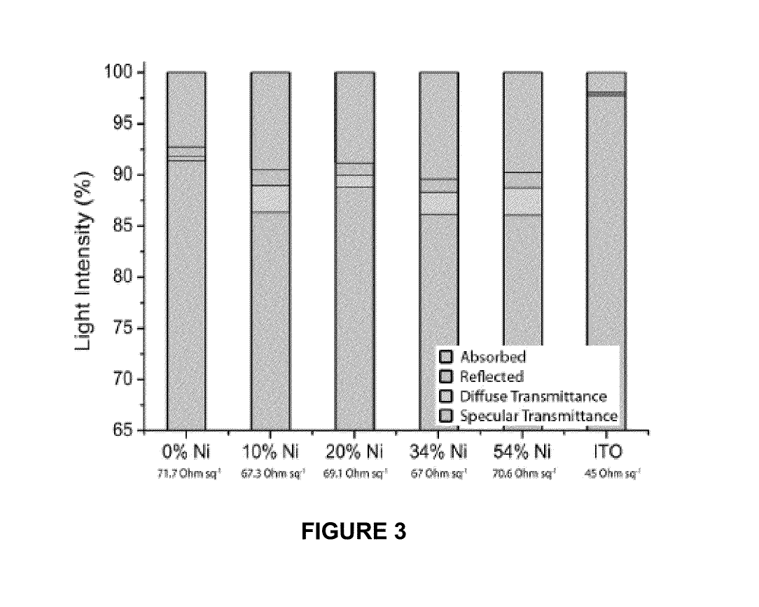

FIG. 3 compares the absorbance, reflectance, diffuse transmittance, and specular transmittance of nanowire films with different nickel contents. The copper nanowire film exhibits relatively little reflectance and scattering of light. Upon alloying with nickel, the absorbance increased by nearly 2.5% when the nickel content is increased from 0 to 54%. The scattering also increased by 2.3% over this same range, likely because the diameter of the nanowires increased from 75 nm to 116 nm. The reflectance of the film increased marginally with increased nickel content to a maximum of 0.5%. Thus, most of the decrease in transmittance through nanowire films upon alloying with nickel is due to increased absorbance and scattering.

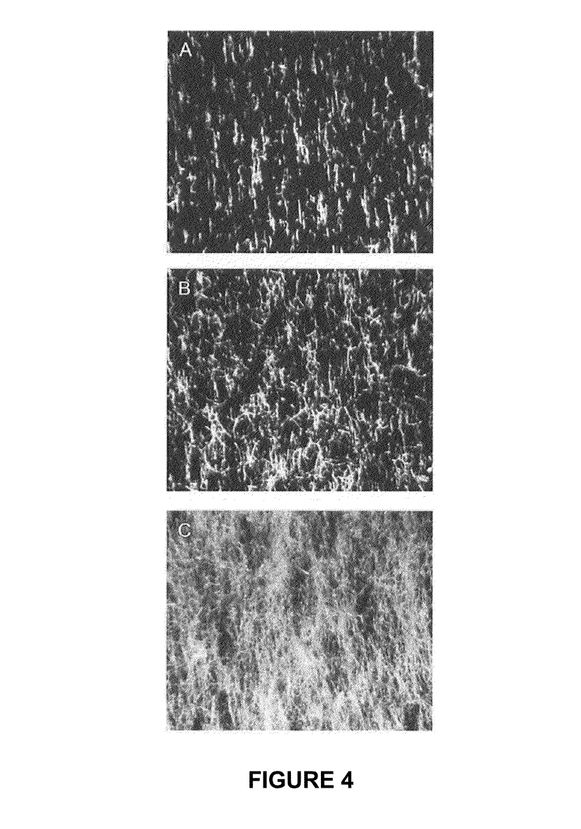

Advantageously, alloying copper nanowires with nickel imbues them with the ability to be manipulated in a magnetic field. FIG. 4 shows dark-field microscopy images of nanowire films of different densities that were coated with nickel under a magnetic field of 230 Gauss, clearly showing alignment of the nanowires. Higher field strengths can be used for even better alignment.

Any patents or publications mentioned in this specification are indicative of the levels of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present examples along with the methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A conductive film comprising a network of cupronickel nanowires (NiCuNWs), said conductive film having a sheet resistance of less than about 1,000 Ω/sq.

2. (canceled)

3. (canceled)

4. The conductive film of claim 1, wherein the conductive film has a transparency greater than about 60%.

5. (canceled)

6. The conductive film of claim 1, wherein the cupronickel nanowires comprise a cupronickel alloy.

7. The conductive film of claim 1, wherein the conductive film comprises at least one supportive material, wherein the supportive material is selected from the group consisting of cellulose materials, glues, polymeric materials, and overcoat materials.

8. The conductive film of claim 1, wherein the conductive film is flexible.

9. The conductive film of claim 1, wherein the cupronickel nanowires have a length of about 1 to about 500 microns and a diameter of about 10 nm to about 1 micron.

10. The conductive film of claim 1, wherein the cupronickel nanowires have a length of about 1 to about 50 microns and a diameter of about 70 to about 120 nm.

11. The conductive film of claim 1, wherein the cupronickel nanowire comprises a shell having a polycrystalline arrangement.

12. A method of producing cupronickel nanowires (NiCuNWs), said method comprising:
combining copper nanowires (CuNWs), at least one nickel salt, at least one reducing agent, at least one surfactant, and at least one solvent to form a mixture;
reacting the mixture for time necessary to reduce the nickel ions to form NiCuNWs

13. The method of claim 12, wherein the mixture does not include a hydroxide salt such as NaOH.

14. The method of claim 12, wherein the reacting comprises heating.

15. (canceled)

16. The method of claim 12, further comprising collecting the NiCuNWs

17. The method of claim 12, further comprising washing the collected NiCuNWs with a wash solution.

18. The method of claim 12, wherein the reducing agent comprises a species selected from the group consisting of hydrazine, ascorbic acid, L(+)-ascorbic acid, isoascorbic acid, ascorbic acid derivatives, oxalic acid, formic acid, phosphites, phosphorous acid, sulfites, sodium borohydride, and combinations thereof.

19. (canceled)

20. The method of claim 12, wherein the surfactant comprises a species selected from the group consisting of polyethylene glycol (PEG), polyethylene oxide (PEO), polypropylene glycol, polyvinyl pyrrolidone (PVP), cationic polymers, nonionic polymers, anionic polymers, hydroxyethylcellulose (HEC), acrylamide polymers, poly(acrylic acid), carboxymethylcellulose (CMC), sodium carboxymethylcellulose (Na CMC), hydroxypropylmethylcellulose, polyvinylpyrrolidone (PVP), BIOCARE™ polymers, DOW™ latex powders (DLP), ETHOCEL™ ethylcellulose polymers, KYTAMER™ PC polymers, METHOCEL™ cellulose ethers, POLYOX™ water soluble resins, SoftCAT™ polymers, UCARE™ polymers, gum arabic, sorbitan monolaurate, sorbitan monopalmitate, sorbitan monostearate, sorbitan tristearate, sorbitan monooleate, sorbitan trioleate, polyoxyethylene (20) sorbitan monolaurate, polyoxyethylene (20) sorbitan monopalmitate, polyoxyethylene (20) sorbitan monostearate, polyoxyethylene (20) sorbitan monooleate, polyoxyethylene sorbitan trioleate, polyoxyethylene sorbitan tristearate, cetyltrimethylammonium bromide (CTAB), hexadecyltrimethylammonium bromide (HTAB), cetyltrimethylammonium hydrogen sulfate; sodium dodecyl sulfate, ammonium alkyl sulfates, alkyl (C₁₀-C₁₈) carboxylic acid ammonium salts, sodium sulfosuccinates and esters thereof, dioctyl sodium sulfosuccinate, alkyl (C₁₀-C₁₈) sulfonic acid sodium salts, di-anionic sulfonate surfactants, t-octylphenoxypolyethoxyethanol, other octoxynols, and combinations thereof.

21. (canceled)

22. The method of claim 12, wherein the at least one nickel salt comprises a nickel (II) salt selected from the group consisting of nickel (II) acetate, nickel (II) acetate tetrahydrate, nickel (II) bromide, nickel (II) carbonate, nickel (II) chlorate, nickel (II) chloride, nickel (II) cyanide, nickel (II) fluoride, nickel (II) hydroxide, nickel (II) bromate, nickel (II) iodate, nickel (II) iodate tetrahydrate, nickel (II) iodide, nickel (II) nitrate hexahydrate, nickel (II) oxalate, nickel (II) orthophosphate, nickel (II) pyrophosphate, nickel (II) sulfate, nickel (II) sulfate heptahydrate, and nickel (II) sulfate hexahydrate.

23. (canceled)

24. The method of claim 12, wherein the at least one solvent comprises a species selected from the group consisting of methanol, ethanol, isopropanol, butanol, ethylene glycol, propylene glycol, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof.

25.-27. (canceled)

28. A cupronickel nanowire comprising a substantially copper core with a cupronickel alloy shell.

29. The cupronickel nanowire of claim 28, having a length of about 1 to 500 microns.

30. (canceled)

31. The cupronickel nanowire of claim 28, having a diameter of about 10 nm to about 1 micron.

32. (canceled)

33. (canceled)
